(19) United States
(12) Patent Application Publication
(10) Pub. No.: US 2022/0049963 A1
(43) Pub. Date: Feb. 17, 2022

(54) SERVER APPARATUS, INFORMATION SYSTEM, VEHICLE, MEDIUM, AND METHOD OF OPERATING INFORMATION SYSTEM

(71) Applicant: Toyota Jidosha Kabushiki Kaisha, Toyota-shi Aichi-ken (JP)

(72) Inventors: Yuki Tatsumoto, Nagoya-shi (JP); Kazumi Aono, Toyota-shi (JP); Tetsushi Okamoto, Nisshin-shi (JP); Naoki Uenoyama, Nagoya-shi (JP); Jaya Bharath R. Goluguri, McKinney, TX (US)

(21) Appl. No.: 17/397,148

(22) Filed: Aug. 9, 2021

(30) Foreign Application Priority Data
Aug. 11, 2020 (JP) 2020-136002

(51) Int. Cl. G01C 21/34; H04W 4/024; H04W 4/44; H04W 4/029; H04W 12/02

(52) U.S. Cl. CPC G01C 21/343; H04W 4/024; H04W 12/02; H04W 4/029; H04W 4/44

(57) ABSTRACT

A server apparatus includes a communication interface and a controller configured to transmit/receive information to/from another apparatus using the communication interface, wherein the controller is configured to receive information on a route from a terminal apparatus, and transmit, to the terminal apparatus, an instruction that prohibits the terminal apparatus from outputting the information on the route when the route has a tendency to be confidential, and an instruction that permits the terminal apparatus to output the information on the route when the route does not have the tendency to be confidential.

### CROSS-REFERENCE TO RELATED APPLICATION

This application claims priority to Japanese Patent Application No. 2020-136002, filed on Aug. 11, 2020, the entire contents of which are incorporated herein by reference.

### TECHNICAL FIELD

The present disclosure relates to a server apparatus, an information system, a vehicle, a medium, and a method of operating an information system.

### BACKGROUND

An information system for collecting and providing various information in accordance with travel of a user is known. For example, technology for collecting information acquired by a vehicle used by the user and using the information for monitoring the road environment has been proposed, as in patent literature (PTL) 1. Furthermore, technology for providing a user of a ride share service with positional information on a vehicle collected from the vehicle has been proposed (PTL 2).

### CITATION LIST

### Patent Literature

PTL 1: JP 2019-79303 A

PTL 2: WO2019136066

### SUMMARY

There is room for improving convenience for a user who travels.

A server apparatus according to the present disclosure includes:

a communication interface; and

a controller configured to transmit/receive information to/from another apparatus using the communication interface, wherein

the controller is configured to receive information on a route from a terminal apparatus, and transmit, to the terminal apparatus, an instruction that prohibits the terminal apparatus from outputting the information on the route when the route has a tendency to be confidential, and an instruction that permits the terminal apparatus to output the information on the route when the route does not have the tendency to be confidential.

A medium according to the present disclosure is a non-transitory medium, readable by a terminal apparatus configured to transmit/receive information to/from another apparatus, storing a program that, when executed by a controller of the terminal apparatus, causes the terminal apparatus to:

transmit information on a route to a server apparatus;

receive, from the server apparatus, an instruction that prohibits output of the information on the route when the route has a tendency to be confidential and an instruction that permits output of the information on the route when the route does not have the tendency to be confidential; and

refrain from outputting the information on the route when the instruction that prohibits output is received and output the information on the route when the instruction that permits output is received.

A method of operating a system according to the present disclosure is a method of operating an information system including a terminal apparatus and a server apparatus configured to transmit/receive information to/from each other, the method including:

transmitting, by the terminal apparatus to the server apparatus, information on a route;

transmitting, by the server apparatus to the terminal apparatus, an instruction that prohibits output of the information on the route when the route has a tendency to be confidential and an instruction that permits output of the information on the route when the route does not have the tendency to be confidential; and

refraining, by the terminal apparatus, from outputting the information on the route when the instruction that prohibits output is received and outputting the information on the route when the instruction that permits output is received.

According to the present disclosure, convenience can be improved for a user who travels.

### BRIEF DESCRIPTION OF THE DRAWINGS

In the accompanying drawings:

FIG. 1 is a diagram illustrating an example configuration of an information system;

FIG. 2 is a diagram illustrating an example configuration of a terminal apparatus;

FIG. 3 is a diagram illustrating an example configuration of a server apparatus;

FIG. 4 is a sequence diagram illustrating an example of operations of an information system; and

FIG. 5 is a flowchart illustrating an example of operations of the server apparatus.

### DETAILED DESCRIPTION

Embodiments are described below.

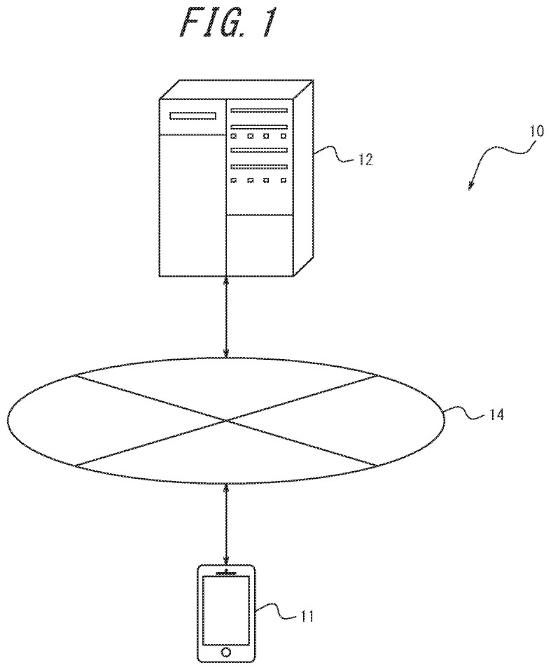

FIG. 1 is a diagram illustrating an example configuration of an information system in an embodiment. The information system 10 helps users to improve the convenience of traveling by using a vehicle dispatch service such as a taxi or ride sharing, or by driving a vehicle on their own. The information system 10 includes a terminal apparatus 11 and a server apparatus 12 that are communicably connected to each other via a network 14. The terminal apparatus 11 is a portable information terminal carried by the user or is a vehicle-mounted apparatus. The terminal apparatus 11 is, for example, a cellular phone, a smartphone, a tablet, a personal computer (PC), or a navigational device. The server apparatus 12 is, for example, a server apparatus that belongs to a cloud computing system or other computing system and implements various functions. The network 14 may, for example, be the Internet, but may include an ad hoc network, a local area network (LAN), a metropolitan area network (MAN), another network, or any combination thereof.

The terminal apparatus 11 transmits the route to the server apparatus 12 when the user travels. The route includes a route that was searched for (searched route) or a route actually travelled (travel route). The server apparatus 12 transmits, to the terminal apparatus 11, an instruction (prohibition instruction) to prohibit output of information on the route (simply referred to as the route when no distinction is made between a searched route and a travel route) when the route has a tendency to be confidential (confidentiality tendency) and an instruction (permission instruction) to permit output of the information on the route when the route does not have the confidentiality tendency. When the route includes a point where confidentiality is requested with a certain frequency, the route has a confidentiality tendency. The terminal apparatus 11 does not output the information on the route when receiving the prohibition instruction and outputs the information on the route when receiving the permission instruction. Even when different users share the vehicle dispatch service or navigation function using the terminal apparatus 11, a user who wants the route to be confidential can prevent the route history from being seen by other users, thereby improving the convenience for the user who wants the route to be confidential.

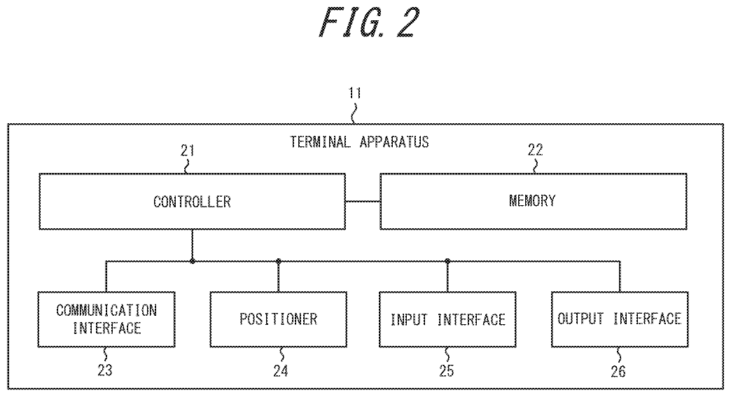

FIG. 2 illustrates an example configuration of the terminal apparatus 11. The terminal apparatus 11 includes a controller 21, a memory 22, a communication interface 23, a positioner 24, an input interface 25, and an output interface 26. The terminal apparatus 11 may, for example, be a cellular phone, a smartphone, a tablet, or a PC and is carried by the user. The user operates the terminal apparatus 11 to use a dispatch service, such as a taxi or ride sharing, and travels in the dispatched vehicle while carrying the terminal apparatus 11. Alternatively, the terminal apparatus 11 may be a vehicle-mounted apparatus that is mounted in the vehicle driven by the user and has a navigational function.

The controller 21 includes one or more processors, one or more dedicated circuits, or a combination thereof, The processor is a general purpose processor, such as a central processing unit (CPU), or a dedicated processor specialized for a particular process. The dedicated circuit is, for example, a field-programmable gate array (FPGA) or an application specific integrated circuit (ASIC). The controller 21 executes information processing related to operations of the terminal apparatus 11 while controlling each component of the terminal apparatus 11,

The memory 22 includes, for example, one or more semiconductor memories, one or more magnetic memories, one or more optical memories, or a combination of at least two of these types. The semiconductor memory is, for example, random access memory (RAM) or read only memory (ROM). The RAM is, for example, static RAM (SRAM) or dynamic RAM (DRAM). The ROM is, for example, electrically erasable programmable ROM (EEPROM). The memory 22 functions as a main memory, auxiliary memory, or cache memory, for example. The memory 22 stores information used for operations of the terminal apparatus 11 and information resulting from operations of the terminal apparatus 11.

The communication interface 23 includes one or more interfaces for communication. Examples of the interface for communication include an interface conforming to a mobile communication standard, such as Long Term Evolution (LTE), 4th Generation (4G), or 5th Generation (5G), or a LAN interface. The communication interface 23 receives information used for operations of the terminal apparatus 11 and transmits information resulting from operations of the terminal apparatus 11. The terminal apparatus 11 is connected to the network 14 by the communication interface 23 through a nearby router apparatus or a mobile communication base station and communicates information with other apparatuses via the network 14.

The positioner 24 includes one or more Global Navigation Satellite System (GNSS) receivers. GNSS includes, for example, Global Positioning System (GPS), Quasi-Zenith Satellite System (QZSS), Global Navigation Satellite System (GLONASS), and/or Galileo. The positioner 24 acquires positional information for the terminal apparatus 11.

The input interface 25 includes one or more interfaces for input. The interface for input is, for example, a physical key, a capacitive key, a pointing device, a touch screen integrally provided with a display, or a microphone that accepts audio input. The interface for input may further include a camera or IC card reader for input of a captured image or image code. The input interface 25 accepts an operation for inputting information used for operations of the terminal apparatus 11 and transmits the inputted information to the controller 21.

The output interface 26 includes one or more interfaces for output. The output interface is, for example, an external or built-in display for outputting information as images and/or video, a speaker for outputting information as audio, or a connection interface with an external output device. The display is, for example, a liquid crystal display (LCD) or an organic electro luminescence (EL) display. The output interface 26 outputs information resulting from operations of the terminal apparatus 11.

The functions of the terminal apparatus 11 are achieved by a processor included in the controller 21 executing a program. The program may be recorded on a computer readable recording medium. The computer readable recording medium is, for example, a magnetic recording device, an optical disc, a magneto-optical recording medium, or a semiconductor memory. For example, the program is distributed after being recorded on a portable recording medium such as a Digital Versatile Disc (DVD) or a Compact Disc (CD)-ROM. The program may be distributed by being stored in the storage of a server apparatus and transferred from the server apparatus to another computer. Some or all of the operations of the terminal apparatus 11 may be performed by a dedicated circuit included in the controller 21.

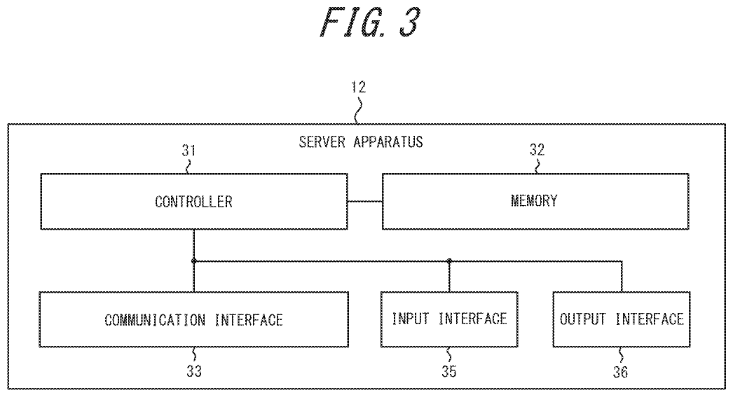

FIG. 3 is a diagram illustrating an example configuration of the server apparatus 12. The server apparatus 12 includes a controller 31, a memory 32, a communication interface 33, an input interface 35, and an output interface 36. The server apparatus 12 is, for example, a server computer that belongs to a cloud computing system or other computing system and acts as a server that implements various functions. The server apparatus 12 may be one or more server computers that are connected to communicate with each other and operate in conjunction with each other.

The controller 31 includes one or more processors, one or more dedicated circuits, or a combination thereof. The processor may, for example, be a general purpose processor, such as a CPU, or a dedicated processor, such as a graphics processing unit (GPU), dedicated to a particular process. The dedicated circuit is, for example, an FPGA or an ASIC. The controller 31 executes information processing related to operations of the server apparatus 12 while controlling each component of the server apparatus 12.

The memory 32 includes, for example, one or more semiconductor memories, one or more magnetic memories, one or more optical memories, or a combination of at least two of these types, to function as main memory, auxiliary memory, or cache memory. The semiconductor memory is, for example, RAM or ROM. The RAM is, for example, SRAM or DRAM. The ROM is, for example, EEPROM. The memory 32 stores information used for operations of the server apparatus 12 and information resulting from operations of the server apparatus 12.

In the server apparatus 12, the controller 31 and the memory 32 may be connected via, a bus or may be directly connected to each other without passing through a bus. Alternatively, the controller 31 may encompass the memory 32 and be configured integrally with the memory 32.

The communication interface 33 includes one or more interfaces for communication. The interface for communication is, for example, a LAN interface. The communication interface 33 receives information used for operations of the server apparatus 12 and transmits information resulting from operations of the server apparatus 12. The server apparatus 12 is connected to the network 14 by the communication interface 33 and communicates information with other devices via the network 14.

The input interface 35 includes one or more interfaces for input. The interface for input is, for example, a physical key, a capacitive key, a pointing device, a touch screen integrally provided with a display, or a microphone that accepts audio input. The interface for input may further include a camera or IC card reader for input of a captured image or image code. The input interface 35 accepts an operation for inputting information used for operations of the server apparatus 12 and transmits the inputted information to the controller 31.

The output interface 36 includes one or more interfaces for output. The interface for output is, for example, a display or a speaker. The display is, for example, an LCD or an organic EL display. The output interface 36 outputs information resulting from operations of the server apparatus 12.

The functions of the server apparatus 12 are achieved by a processor included in the controller 31 executing a control program. The control program is a program that causes the computer to execute the processing of the steps included in the operations of the server apparatus 12 for the computer to achieve the functions corresponding to the processing of the steps. That is, the control program is a program for causing the computer to function as the server apparatus 12. Some or all of the functions of the server apparatus 12 may be implemented by a dedicated circuit included in the controller 31.

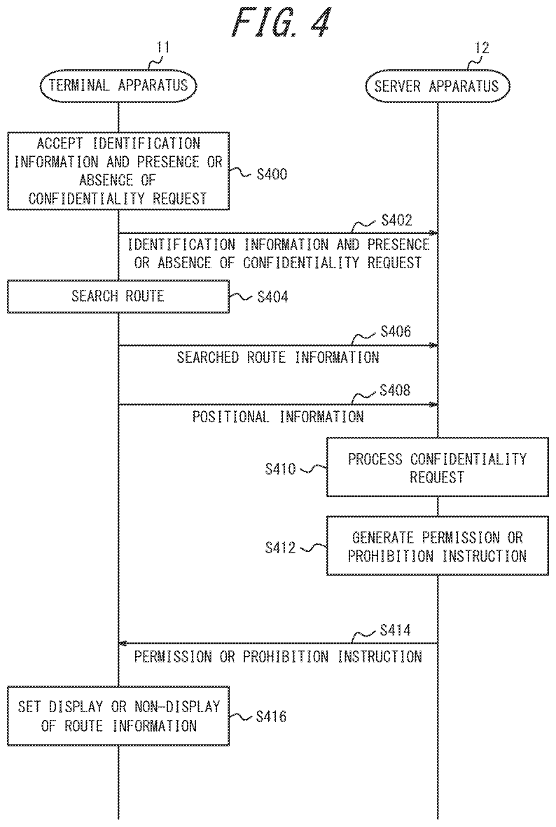

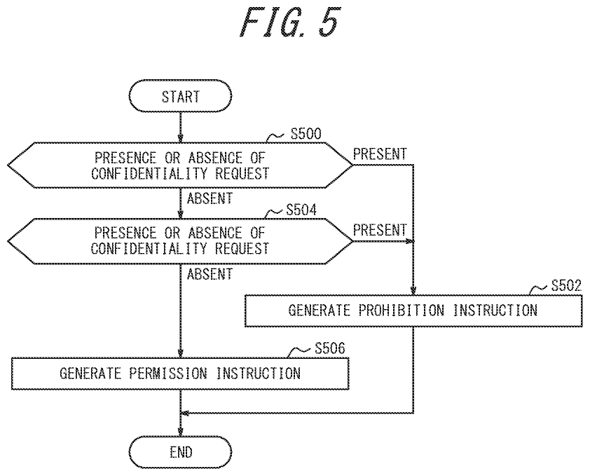

Next, operations of the information system 10 are described with reference to FIG. 4 and FIG. 5.

FIG. 4 is a sequence diagram illustrating operation procedures when the terminal apparatus 11 and the server apparatus 12 operate in cooperation with each other. The procedures of FIG. 4 are an example of procedures performed when a user carrying the terminal apparatus 11 starts to travel.

In step S400, the terminal apparatus 11 accepts input of identification information and of the presence or absence of a confidentiality request from the user. The identification information is a user name that identifies the user, a password, or the like. The confidentiality request is a request seeking confidentiality of the route that the user searches for using the terminal apparatus 11 or the route that the user travels while carrying the terminal apparatus 11. The controller 21 of the terminal apparatus 11 displays words, or outputs audio, inquiring about the presence or absence of a confidentiality request using the output interface 26. The user inputs whether to request confidentiality or not. The controller 21 accepts inputs from the user via the input interface 25. The input of the identification information may be made once when use of the vehicle dispatch application or the navigation function begins and may be omitted when the confidentiality request is inputted. In this case, the identification information is stored in the memory 22.

In step S402, the terminal apparatus 11 transmits the identification information of the user and the information on the presence or absence of the confidentiality request to the server apparatus 12. The controller 21 of the terminal apparatus 11 transmits the information on the presence or absence of the confidentiality request and the identification information to the server apparatus 12 using the communication interface 23. The controller 31 of the server apparatus 12 receives the identification information of the user and the information on the presence or absence of the confidentiality request using the communication interface 33.

In step S404, the terminal apparatus 11 performs a route search in response to an operation by the user. Step S404 is performed when, for example, the user uses the terminal apparatus 11 as a vehicle-mounted apparatus and uses the navigational function. Alternatively, step S404 may be performed when the user operates the terminal apparatus 11 to use a vehicle dispatch service. The controller 21 of the terminal apparatus 11 uses the output interface 26, for example, to display map information stored in the memory 22 or map information received from the server apparatus 12 in accordance with the current position of the terminal apparatus 11, and prompts the user to input a departure point and a destination. The user enters the departure point and the destination, for example by tapping a desired point on the map or entering an address, and instructs that a search be performed. The controller 21 then accepts the input from the user via the input interface 25 and performs the search. The controller 21 then outputs the search result, i.e., the searched route, using the output interface 26.

In step S406, the terminal apparatus 11 transmits information on the searched route to the server apparatus 12. The information on the searched route includes information on the departure point, the destination, and points to be traversed. The controller 21 of the terminal apparatus 11 transmits the information on the searched route to the server apparatus 12 using the communication interface 23. The controller 31 of the server apparatus 12 receives the information on the searched route using the communication interface 33. In step S404, the terminal apparatus 11 may transmit a search request to the server apparatus 12 together with information necessary for the search, receive information on the searched route that was searched for by the server apparatus 12, and output the received information to the user. In this case, the information on the searched route is stored in the server apparatus 12, and step S406 may be omitted. Alternatively, steps S404 and S406 may be omitted if no route search is required, such as when the user is familiar with the route to the destination.

Step S408 is performed when the user users a vehicle dispatch service or starts traveling by driving his/her own vehicle. In step S408, the terminal apparatus 11 transmits positional information on the terminal apparatus 11 to the server apparatus 12. For example, when the controller 21 of the terminal apparatus 11 detects the start of travel from a change in the current position of the terminal apparatus 11, the positional information on the current position is transmitted to the server apparatus 12 using the communication interface 23 in any appropriate cycle (for example, a cycle of several milliseconds to several seconds). The controller 31 of the server apparatus 12 receives the positional information using the communication interface 33. Transmission and reception of the positional information continues until, for example, the current position of the terminal apparatus 11 stops changing and completion of travel is detected by the controller 21. The travel route is formed by the transition of the positional information. In this way, information on the travel route is transmitted from the terminal apparatus 11 to the server apparatus 12. The information on the travel route includes information on the departure point, points to be traversed, and the destination.

In step S410, the server apparatus 12 processes the confidentiality request for the route. The controller 31 of the server apparatus 12 performs processing corresponding to the presence or absence of the confidentiality request received in step S402. When there is a confidentiality request, the controller 31 stores, in the memory 32, the information on the confidentiality request for the searched route that was searched for in step S404 or the travel route specified by the transition of the positional information received in step S408. If the searched route and the travel route differ, the information of the confidentiality request for both routes is stored in the memory 32. For example, for each point included in the route, the controller 31 stores a score indicating the confidentiality request in the memory 32. Points are shop or facility locations, intersections or curves, locations of landmarks, and the like that are discretely mapped on a map in advance. For example, the controller 31 adds a unit score to a point included in the searched route or the travel route for each instance of search or travel. In this way, the requests for confidentiality from one or more terminal apparatuses 11 are accumulated for each point. The frequency at which confidentiality of each point is requested by one or more users is thus accumulated as big data. On the other hand, when there is no confidentiality request, the controller 31 advances to step S412 without storing the information on the confidentiality request in the memory 32.

In step S412, the server apparatus 12 generates a permission or prohibition instruction relating to output of information on the route. The detailed procedure of step S412 is illustrated in FIG. 5. The controller 31 of the server apparatus 12 generates a prohibition instruction to prohibit the terminal apparatus 11 from outputting information on the route when the route confidentiality request is present (step S500: Yes) (step S502). On the other hand, the controller 31 determines the confidentiality tendency of the route in step S504 when there is no confidentiality request for the route (step S500: No). The confidentiality tendency of the route is, for example, determined based on the scores assigned to points included in the route. For example, the controller 31 sums the scores of the points included in the route for each route. The controller 31 determines that the route has a confidentiality tendency when the sum exceeds an appropriately selected reference value and determines that the route does not have a confidentiality tendency when the sum of the scores is equal to or less than the reference value. Alternatively, the controller 31 may determine that the route has a confidentiality tendency when the number of points, included in the route, whose cumulative score exceeds an appropriately selected reference value is greater than an appropriately selected reference number and may determine that the route does not have a confidentiality tendency when the number of points whose cumulative score exceeds the reference value is equal to or less than the reference number. The controller 31 generates a prohibition instruction that prohibits the terminal apparatus 11 from outputting the information on the route when the route has a confidentiality tendency (step S504: Yes) (step S502) and generates a permission instruction that permits the terminal apparatus 11 to output the information on the route when the route does not have a confidentiality tendency (step S504: No) (step S506).

Returning to FIG. 4, in step S414, the server apparatus 12 transmits the prohibition instruction or permission instruction generated in step S410 to the terminal apparatus 11. The controller 31 of the server apparatus 12 transmits the prohibition instruction or permission instruction to the terminal apparatus 11 using the communication interface 33. The controller 21 of the terminal apparatus 11 receives the prohibition instruction or permission instruction using the communication interface 23.

In step S416, the terminal apparatus 11 makes a display setting or non-display setting of the information on the route. When the permission instruction is received, the controller 21 of the terminal apparatus 11 makes a setting such that the history of the searched route that was searched for in step S404 or the actually travelled route generated from the transition of the positional information transmitted to the server apparatus 12 in step S408 is displayed in accordance with operation by the user. Conversely, when the prohibition instruction is received, the controller 21 makes a setting such that the history of the searched route or the travel route is not displayed even if the user performs an operation. The controller 21 may be configured to make a setting only when user consent is received by the input interface 25 after the user is notified, by the output interface 26, that a setting for display or non-display is being made.

According to the procedures described in FIGS. 4 and 5, information is not outputted on a route that has a confidentiality tendency, i.e., a route that includes a point for which confidentiality is highly likely to be requested by many users. Even when different users share the vehicle dispatch service or navigation function using the terminal apparatus 11, a user who wants the route to be confidential can therefore prevent the route history from being seen by other users. This can improve the convenience for the user who wants the route to be confidential. Furthermore, even when the user searches or travels without making a confidentiality request, the route can be made confidential in consideration of a potential confidentiality request from the user.

In step S410 of FIG. 4, the controller 31 of the server apparatus 12 in a modification acquires the date and time using a clock function and scores each point in association with information on the date and time (including the day of the week) at which the confidentiality request was made. When determining the confidentiality tendency of the route in step S412, the controller 31 then accumulates the score of each point on each day of the week or each time slot and refers to the score corresponding to the day of the week or time slot when the information on the route was received. If the cumulative score of a certain point is not higher than the cumulative scores at other points but is higher when aggregated on a specific day of the week or time slot, the point has a day of the week or time slot characteristic. In such cases, the controller 31 changes the reference value for determining the confidentiality tendency of the route in accordance with the day of the week or the time slot, so that the route including the point having the day of the week or the time slot characteristic is determined to have a confidentiality tendency. It thus becomes possible to determine the confidentiality tendency of the route while taking into account the day of the week or time slot characteristics of points. For example, when a relatively large number of users wish to keep confidential a visit to a commercial facility holding an event on a specific day of the week or a detour during work hours, the needs of such users can be addressed in detail.

Furthermore, when the controller 31 manages information on an activity schedule of the user in association with the identification information of the user, the controller 31 may aggregate the confidentiality requests taking into account the activity schedule of the user, i.e., the date and time, and determine the confidentiality tendency. The controller 31 scores each point in association with the activity schedule of the user when a confidentiality request is received, for example. The score at a certain point is aggregated separately for when there is a specific scheduled activity and when there is no scheduled activity. When there is a scheduled activity at the time the information on the route is received, the controller 31 refers to the score at the time of the scheduled activity to determine the confidentiality tendency of the route. For example, suppose a confidentiality request is obtained from many users for a point visited on a date and time when a personal event is scheduled. In this case, when the date and time of receipt of the information on the route matches or is close to the date and time at which a personal event of the user is scheduled, the score associated with the existence of a scheduled activity at each point is aggregated to determine the confidentiality tendency of the route. For example, suppose that many users wish to keep a visit to a jewelry shop or the like immediately before their wedding anniversary confidential from their spouse in order to keep an anniversary gift secret from their spouse until their anniversary. In this case, when the date and time of receipt of information on the route is immediately before the user's anniversary (including a range of an appropriately selected number of days), the controller 31 can determine that the route has a confidentiality tendency when the route includes a jewelry shop. The user's plans can thus be supported in detail.

In the above-described embodiment, a processing/control program that specifies operations of the terminal apparatus 11 may be stored in the server apparatus 12 and be downloaded onto the terminal apparatus 11 via the network 14. The processing/control program may also be stored on a non-transitory recording/storage medium readable by each apparatus, and each apparatus may read the program from the medium.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. A server apparatus comprising:
a communication interface; and
a controller configured to transmit/receive information to/from another apparatus using the communication interface, wherein
the controller is configured to receive information on a route from a terminal apparatus, and transmit, to the terminal apparatus, an instruction that prohibits the terminal apparatus from outputting the information on the route when the route has a tendency to be confidential, and an instruction that permits the terminal apparatus to output the information on the route when the route does not have the tendency to be confidential.

2. The server apparatus of claim 1, wherein the route includes a route searched for or traveled by the terminal apparatus.

3. The server apparatus of claim 1, wherein the controller is configured to determine the tendency to be confidential based on a request for confidentiality received from the terminal apparatus or another terminal apparatus.

4. The server apparatus of claim 3, wherein the controller is configured to generate the instruction that prohibits or permits output by taking into account a first date and time of receipt of the request for confidentiality and a second date and time of receipt of the information on the route.

5. The server apparatus of claim 4, wherein the controller is configured to acquire the first date and time from information on an activity schedule corresponding to a terminal apparatus that transmits the request for confidentiality.

6. The server apparatus of claim 4, wherein the controller is configured to acquire the second date and time from information on an activity schedule corresponding to a terminal apparatus that transmits the information on the route.

7. An information system comprising the server apparatus of claim 1 and the terminal apparatus.

8. A vehicle configured to communicate with the server apparatus of claim 1 by having the terminal apparatus mounted thereon.

9. A non-transitory medium, readable by a terminal apparatus configured to transmit/receive information to/from another apparatus, storing a program that, when executed by a controller of the terminal apparatus, causes the terminal apparatus to:
transmit information on a route to a server apparatus;
receive, from the server apparatus, an instruction that prohibits output of the information on the route when the route has a tendency to be confidential and an instruction that permits output of the information on the route when the route does not have the tendency to be confidential; and
refrain from outputting the information on the route when the instruction that prohibits output is received and output the information on the route when the instruction that permits output is received.

10. The non-transitory medium of claim 9, wherein the route includes a route searched for or traveled by the terminal apparatus.

11. The non-transitory medium of claim 9, wherein the tendency to be confidential is determined by the server apparatus based on a request for confidentiality received from the terminal apparatus or another terminal apparatus.

12. The non-transitory medium of claim 11, wherein the instruction that prohibits or permits output is generated by the server apparatus taking into account a first date and time of receipt of the request for confidentiality and a second date and time of receipt of the information on the route.

13. The non-transitory medium of claim 12, wherein the first date and time are acquired by the server apparatus from information on an activity schedule corresponding to a terminal apparatus that transmits the request for confidentiality.

14. The non-transitory medium of claim 12, wherein the second date and time are acquired by the server apparatus from information on an activity schedule corresponding to a terminal apparatus that transmits the information on the route.

15. A method of operating an information system comprising a terminal apparatus and a server apparatus configured to transmit/receive information to/from each other, the method comprising:
transmitting, by the terminal apparatus to the server apparatus, information on a route;
transmitting, by the server apparatus to the terminal apparatus, an instruction that prohibits output of the information on the route when the route has a tendency to be confidential and an instruction that permits output of the information on the route when the route does not have the tendency to be confidential; and
refraining, by the terminal apparatus, from outputting the information on the route when the instruction that prohibits output is received and outputting the information on the route when the instruction that permits output is received.

16. The method of operating an information system of claim 15, wherein the route includes a route searched for or traveled by the terminal apparatus.

17. The method of operating an information system of claim 15, further comprising determining, by the server apparatus, the tendency to be confidential based on a request for confidentiality received from the terminal apparatus or another terminal apparatus.

18. The method of operating an information system of claim 17, further comprising generating, by the server apparatus, the instruction that prohibits or permits output by taking into account a first date and time of receipt of the request for confidentiality and a second date and time of receipt of the information on the route.

19. The method of operative an information system of claim 18, further comprising acquiring, by the server apparatus, the first date and time from information on an activity schedule corresponding to a terminal apparatus that transmits the request for confidentiality.

20. The method of operating an information system of claim 18, further comprising acquiring, by the server apparatus, the second date and time from information on an activity schedule corresponding to a terminal apparatus that transmits the information on the route.
